(19) United States
(12) Patent Application Publication
(10) Pub. No.: US 2007/0261306 A1
(43) Pub. Date: Nov. 15, 2007

(54) LIFTGATE DRIVE UNIT HAVING INTEGRAL MOTOR AND ASSIST

(76) Inventors: Ronald J. Hanna, Mancelona, MI (US); Anthony P. Voegeli JR., Ft. Wayne, IN (US); Michael A. Slumba, Clarkston, MI (US); Mary A. Slumba, Clarkston, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/746,248

(22) Filed: May 9, 2007

Related U.S. Application Data
(60) Provisional application No. 60/799,698, filed on May 11, 2006.

(51) Int. Cl. E06B 3/68

(52) U.S. Cl. 49/52

(57) ABSTRACT

A drive unit is provided for driving a liftgate of a motor vehicle between closed and open positions. The drive unit includes an outer tube having an end configured to couple the drive unit to one of the liftgate or the motor vehicle. The drive unit also includes an inner tube having an end configured to couple the drive unit to the other of the liftgate or the motor vehicle. The inner tube is telescopically engaged with the outer tube. The inner tube is movable between a retracted position and an extended position relative to the outer tube. An actuator is operative for actuating the inner tube relative to the outer tube between the retracted position and the extended position and causing movement of the liftgate between closed and open positions, respectively. The motor drive is housed within the outer tube. A biasing member is connected between the outer tube and the inner tube. The biasing member biases the inner tube relative to the outer tube and assists actuation of the inner tube toward the extended position.

### REFERENCE TO RELATED APPLICATIONS

This application claims priority to U.S. provisional patent application No. 60/799,698, which was filed May 11, 2006 and is incorporated herein by reference in its entirety.

### FIELD OF THE INVENTION

The invention relates to a drive unit for use with a liftgate of a motor vehicle. More particularly, the invention relates a liftgate drive unit having an integral motor and biasing member assist.

### BACKGROUND OF THE INVENTION

Automotive vehicles typically include a cargo space and an entrance formed in a vehicle wall providing access to the cargo space. Some vehicles, such as sport utility vehicles or vans, also typically include a liftgate, which covers the entrance in a closed position and which movable to an open position to allow access to the cargo space through the entrance. Liftgates can be made to swing about the hinges between the closed and open positions. In the latter case, it is known to provide a dampener or strut to bias and hold the liftgate toward the open position. It is also known to provide an actuator for automatically moving the liftgate between the closed and open positions. It remains desirable to design a compact drive unit that integrates a strut and an actuator that is compact in size while maintaining or exceeding the performance of conventional struts and actuators.

### SUMMARY OF THE INVENTION

According to one aspect, a drive unit is provided for driving a liftgate of a motor vehicle between closed and open positions. The drive unit includes an outer tube having an end configured to couple the drive unit to one of the liftgate or the motor vehicle. The drive unit also includes an inner tube having an end configured to couple the drive unit to the other of the liftgate or the motor vehicle. The inner tube is telescopically engaged with the outer tube. The inner tube is movable between a retracted position and an extended position relative to the outer tube. An actuator is operative for actuating the inner tube relative to the outer tube between the retracted position and the extended position and causing movement of the liftgate between closed and open positions, respectively. The motor drive is housed within the outer tube. A biasing member is connected between the outer tube and the inner tube. The biasing member biases the inner tube relative to the outer tube and assists actuation of the inner tube toward the extended position.

According to another aspect, a drive unit is provided for driving a liftgate of a motor vehicle between closed and open positions. The drive unit includes an extendable strut for movement between retracted and extended positions corresponding with the closed and open positions of the liftgate, respectively. The drive unit includes a screw drive for extending the extendable strut. The drive unit also includes a motor and gear set for actuating the screw drive, wherein the motor and gear set are supported by the extendable strut.

According to another aspect, a drive unit is provided for driving a liftgate of a motor vehicle between closed and open positions. The drive unit includes an extendable strut for movement between retracted and extended positions corresponding with the closed and open positions of the liftgate, respectively. The drive unit includes a screw drive for extending the extendable strut. The drive unit also includes a motor and gear set defining an epicyclic transmission for actuating the screw drive, wherein the motor and gear set are supported by the extendable strut.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is an exploded perspective view of a liftgate drive unit according to the present invention;

FIG. 2 is a partial sectional view of the transmission of the liftgate drive unit of the present invention;

FIG. 3 is a sectional view of the liftgate drive unit in both the retracted and extended positions;

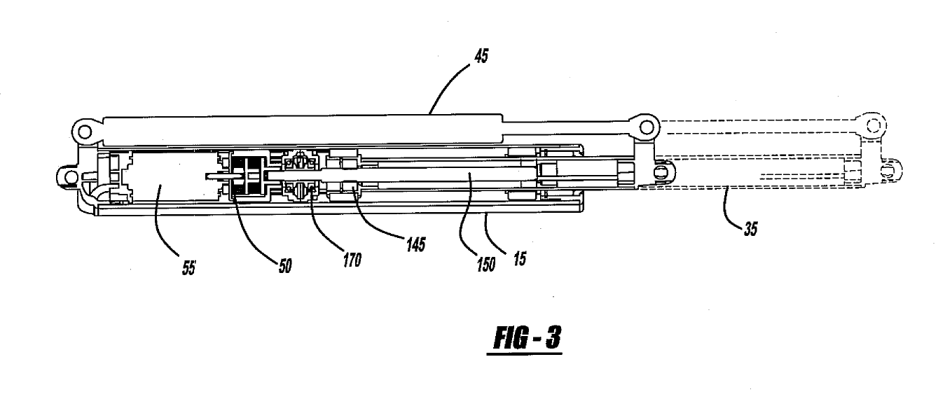

FIG. 4 is a perspective view of the liftgate drive unit in the retracted position;

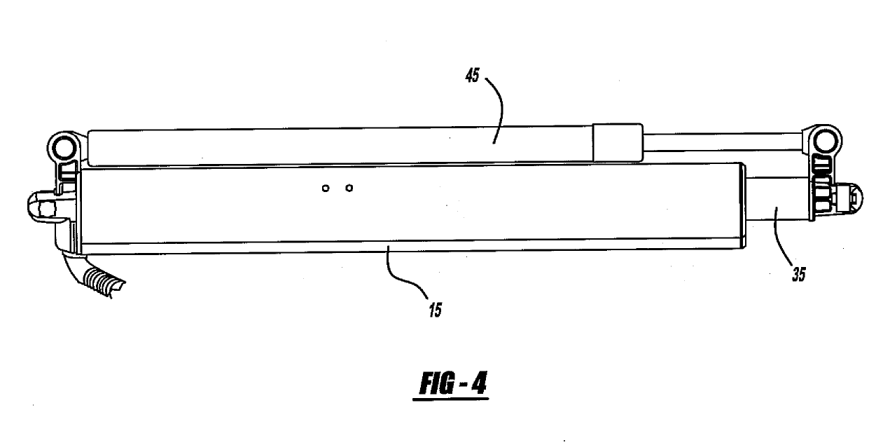

FIG. 5 is a perspective view of the liftgate drive unit in the extended position;

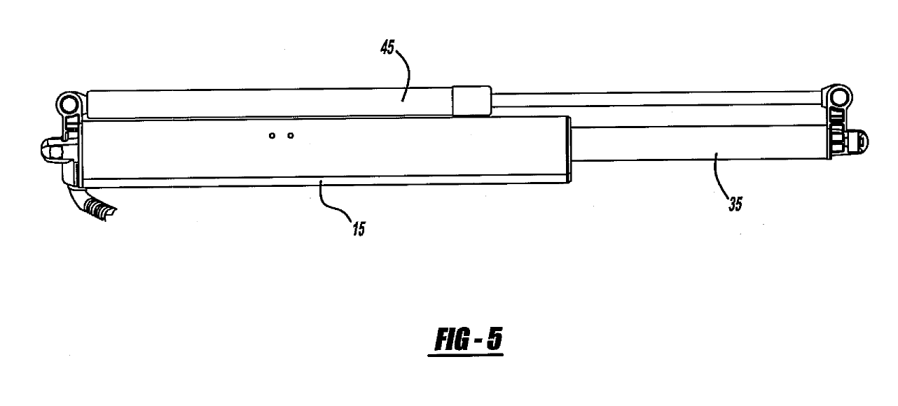

FIG. 6 is an environmental view of the liftgate drive unit attached to a vehicle;

FIG. 7 is an exploded perspective view of the liftgate drive unit according to another embodiment of the invention; and

FIG. 8 is a cross sectional view of the liftgate drive unit of FIG. 7, illustrating a retracted position in solid lines and an extended position in dotted lines.

### DETAILED DESCRIPTION OF THE PREFERRED EMBODIMENTS

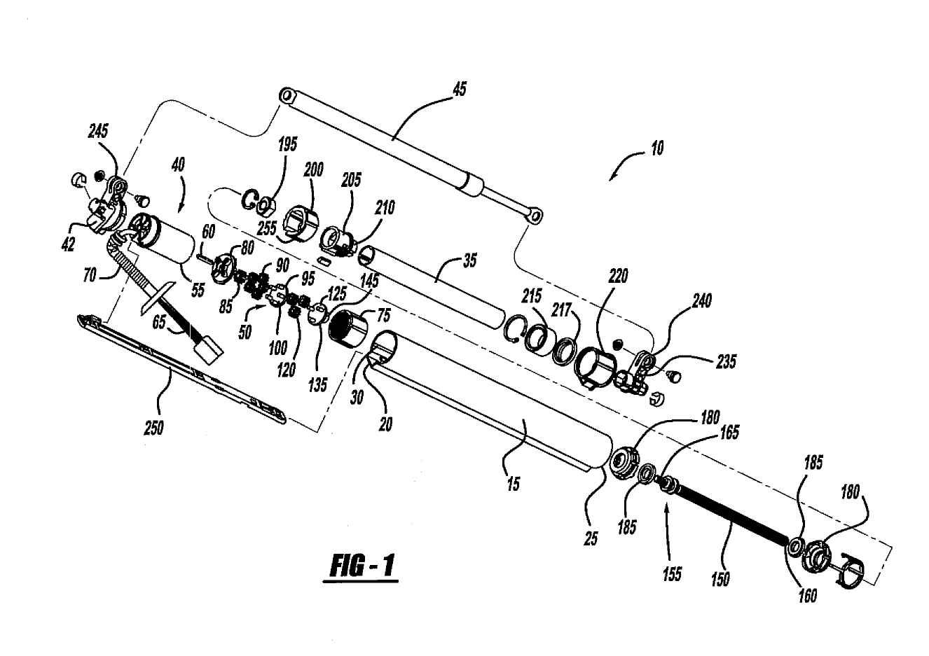

Referring to FIG. 1, there is shown a liftgate drive unit 10 according to one embodiment. The liftgate drive unit 10 includes an outer tube 15 extending between a first end 20 and a second end 25. The outer tube 15 includes a hollow interior 30. The liftgate drive unit 10 also includes an inner tube 35 that is telescopically disposed within the outer tube 15. It should be realized that the term tube as used through out the specification and claims may indicate cross sectional shapes other than round, such a square rectangular, asymmetrical or other cross sectional shapes. A motor assembly 40 associated with the outer tube 15 may be disposed within the hollow interior 30 of the outer tube 15 and is operatively coupled to the inner tube 35 for telescopically moving the inner tube 35 relative to the outer tube 15. It should be appreciated that the motor may be positioned outside of the hollow interior 30 of the outer tube 15, but may be co-lineal with the inner tube 35.

A biasing member in the form of an assist strut 45 may be positioned parallel to the outer tube 15 and is connected at one end to the outer tube 15 and at another end to the inner tube 35 for assisting telescopic movement of the inner tube 35 relative to the outer tube 15. As can be seen in the figures, the assist strut 45 is positioned outside of the outer tube 15 to allow for relatively simple servicing and replacement by simply removing the attachment to the inner and outer tubes 35, 15 and then replacing the assist strut 45 with another and then thereby reattaching.

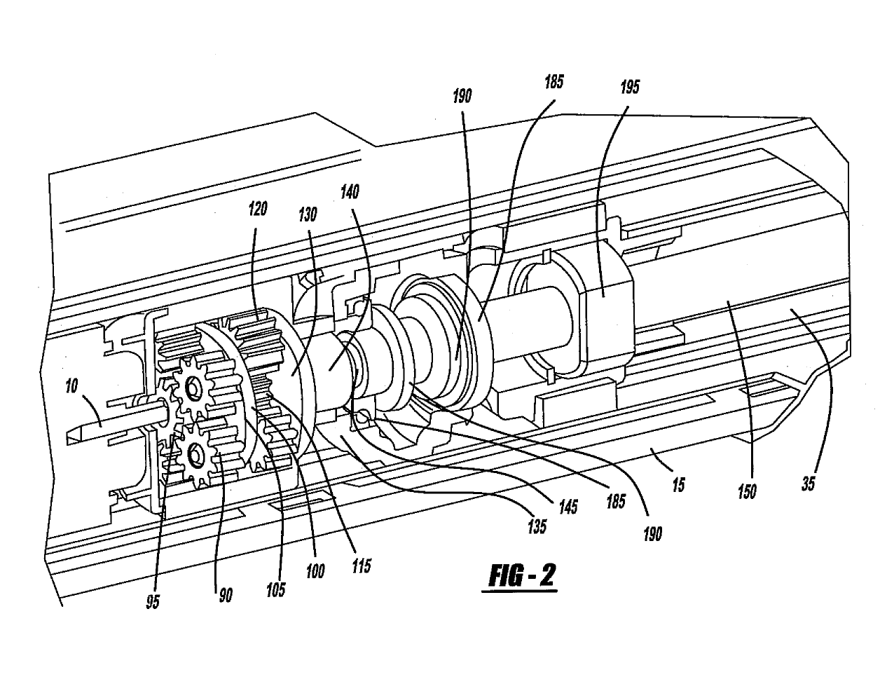

Referring to FIGS. 1 and 2, there is shown the motor assembly 40 and transmission assembly 50 of the liftgate drive unit 10 in accordance with one aspect of the invention. The motor assembly 40 may have an electrical motor 55 including a driveshaft 60 extending from the motor 55. An electrical wire and connector 65 is attached to the motor 55 for providing an electrical power source. In one aspect, the electrical wire may include a grommet 70 sealing to the vehicle body sheet metal and to the motor assembly 40, as shown in FIG. 1. The grommet protects of the wire and directs a routing of the wire.

The driveshaft 60 extending from the motor 55 is linked with the transmission assembly 50. The transmission assembly 50 is epicyclic and includes a housing 75 in which the various transmission components are disposed. The housing 75 includes an end cap 80 for retaining and providing correct axial spacing of the transmission components within the housing 75 and allowing passage of the driveshaft 60 of the electric motor 55. The drive shaft 60 may extend in any manner from the motor 55, but in one aspect it extends co-lineally with respect to the inner tube 35. The driveshaft 60 from the electric motor 55 is coupled to a pinion gear 85.

Surrounding the pinion gear 85 is a first set of planetary gears 90. The first set of planetary gears 90 is disposed on shafts 95 extending from a first carrier plate 100 on a first side 105 of the carrier plate 100. The second side 110 of the first carrier plate 100 includes a pinion gear 115. The pinion gear 115 on the first carrier plate 100 is surrounded by a second set of planetary gears 120. The second set of planetary gears 120 is disposed on shafts 125 formed on a first surface 130 of a second carrier plate 135. A second side 140 of the second carrier plate 135 includes a spline engagement feature 140 for linking with a drive screw 150, as will be discussed in more detail below. In one aspect, the transmission assembly 50 components may be made of plastic, composite or other suitable materials including metal, and powdered metal. As stated above, the motor assembly 40 and the transmission assembly 50 may be disposed within the outer tube 15 of the liftgate drive unit 10. Disposing the motor and transmission assemblies 40, 50 within the outer tube 15 provides an improved packaging of a liftgate drive unit 10. While the transmission assembly 50 has been described as having first 90 and second 120 sets of planetary gears, various numbers of planetary gears may used by the present invention to achieve the design characteristics of various vehicle liftgates.

As referenced above, the liftgate drive unit 10 may include a drive screw 150 linked with the transmission assembly 50. The drive screw 150 extends from a first end 155 to a second end 160 with a corresponding spline feature 165 formed on the first end 155 for linking with the spline feature 145 formed on the second surface 140 of the second carrier plate 135. The drive screw 150 also includes a bearing assembly 170 for supporting the drive screw 150 within the hollow interior 30 of the outer tube 15 providing free rotation of the drive screw 150 within the outer tube 15. The bearing assembly 170 includes a bearing housing 175 including first and second housing members 180 that receive first and second bearing members 185 that are disposed on opposing faces 190 formed on a first end 155 of the drive screw 150. The portion of the drive screw 150 extending from the first end 155 toward the second end 160 is disposed within the inner tube 35. The drive screw 150 includes a drive nut 195 that is positioned about a circumference of the drive screw 150. The drive nut 195 is received within a drive nut sleeve 200 having a corresponding shape to the drive nut 195 such that the drive nut 195 is prevented from rotating relative to the drive screw 150. In this manner, the drive nut 195 is allowed to travel up and down the drive screw 150. The drive nut sleeve 200 is coupled to a drive nut housing 205. The drive nut housing 205 includes a portion 210 that extends within the inner tube 35 such that the drive nut 195 is attached or retained relative to the inner tube 35 at a first end of the inner tube 35. In one aspect, the drive screw 150 may be a lead screw, a ball screw or any other screw drive mechanism.

As described above, the drive screw 150 extends from the first end of the inner tube 35 through the inner tube 35 toward the second end of the inner tube 35. Also as stated above, the inner tube 35 is positioned within the outer tube 15 for telescopic movement of the inner tube 35 relative to the outer tube 15. The second end of the outer tube 15 includes a bushing 215, seal 217 and end cap 220. The bushing 215, seal 217 and end cap 220 provide for the inner tube 35 to penetrate allowing telescopic movement of the inner tube 35 relative to the outer tube 15. Additionally, the inner tube 35 includes an end cap 235 attached to the second end of the inner tube 35. The end cap 235 includes an attachment portion 240 formed thereon to provide for connecting the assist strut 45 such that it runs on an outside of the outer tube 15. Additionally, the first end of the outer tube 15 may include a similar end cap 242 again providing for an attachment portion 245 to attach the assist strut 45 such that it runs outside of the outer tube 15.

The liftgate drive unit 10 may also include a travel sensor switch assembly 250 disposed within the outer tube 15. The travel sensor switch assembly 250 may be disposed within a flat section 255 formed on the outer tube 15. The travel sensor switch assembly 250 is electrically coupled to the motor 55 to allow for regulating the power to the motor when the inner tube 35 has traveled a predetermined distance relative to the outer tube 15. In one aspect, the travel sensor switch is a Hall effect sensor. The Hall effect sensor detects the presence of a magnet 255 associated with the drive nut housing 205 indicating when the inner tube 35 has traveled a desired distance relative to the outer tube 15.

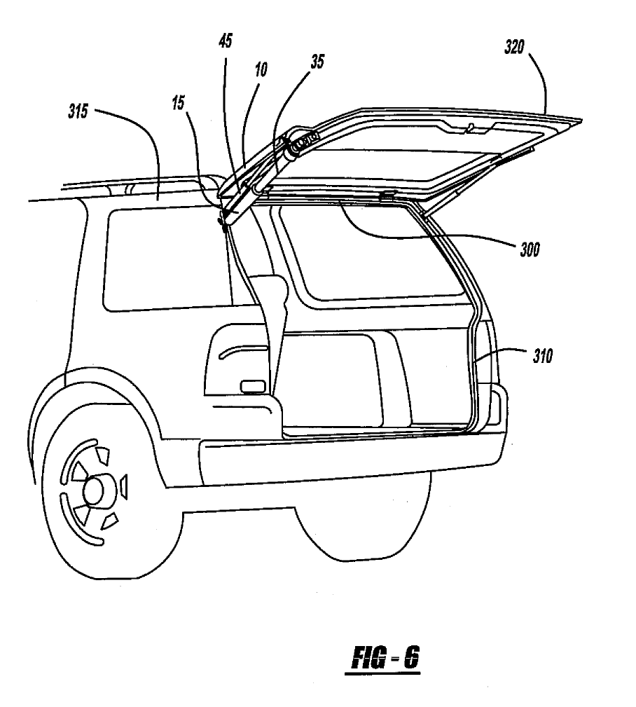

In use, the liftgate drive unit may be attached at one end to a liftgate of a vehicle and at another end to the body of a vehicle, as shown in FIG. 6. In one aspect, the end of the liftgate drive unit 10 having the motor assembly 40 is attached at an upper portion 300 of a liftgate opening 310 to the vehicle. In this manner, the electrical wire 65 or harness may be routed through a roof 315 of the vehicle. The routing through the roof 315 simplifies the electrical connection to the motor assembly 40, as well as improves the positioning of the wire harness within the liftgate opening 310 compared to prior art designs. The opposing end of the liftgate drive unit is attached to the liftgate 320. The electric motor 55 can receive a signal providing an electrical current thereby rotating the drive shaft 60 attached to the motor 55. The drive shaft 60 in turn is coupled to the first pinion gear 85 which in turn rotates the first set of planetary gears 90, causing the first carrier plate 100 to rotate and thereby drive the pinion 115 on the second side 110 of the first carrier plate 100. The second set of planetary gears 120 is driven by the pinion gear 115 on the first carrier plate 100; thereby driving the second carrier plate 135 which is connected to the drive screw 150 via a spline or other connection, as described above. Rotation of the drive screw 150 causes the drive nut 195 to travel up and down the drive screw 150. As stated above, the drive nut 195 is retained by a drive nut sleeve 200 and drive nut housing 205 that is connected to the inner tube 35. Therefore, travel of the drive 195 nut up and down the drive screw 150 causes longitudinal movement of the inner tube 35 relative to the outer tube 15. A magnet 255 disposed on the drive nut housing 205 triggers a Hall effect sensor and a travel sensor switch indicating when the inner tube 35 has traveled a desired distance relative to the outer tube 15. A signal may then be sent to the motor 55 shutting off the driving power.

The assist strut 45 may be coupled to the liftgate drive unit 10 via the end cap 240 disposed on the first end of the outer tube 15 and the end cap 235 connected to the second end of the inner tube 35. The assist strut 45 aids an operator when opening a liftgate of a vehicle by providing an additional force should the electric drive not be utilized.

Once the inner tube 35 has moved to the desired position relative to the outer tube 15 such that a liftgate is in the opened position, the liftgate drive unit 10 is now in the extended position. The liftgate drive unit may then be returned to a retracted position by rotating the motor 55 in an opposing direction, or if the motor 55 is not utilized an operator may exert a force on a liftgate; thereby back driving the electric motor 55 through the transmission assembly 50.

In another embodiment, a clutch may be positioned between the transmission assembly 50 and the drive screw 150 such that the drive screw 150 will be back driven separately from the motor and transmission assemblies 40, 50. The clutch may be a roller type mechanical or an electromagnetic clutch or may be a lead screw clutch that travels up and down a drive screw as disclosed in U.S. patent application Ser. Nos. 11/406104 and 60/732,735 which are herein incorporated by reference.

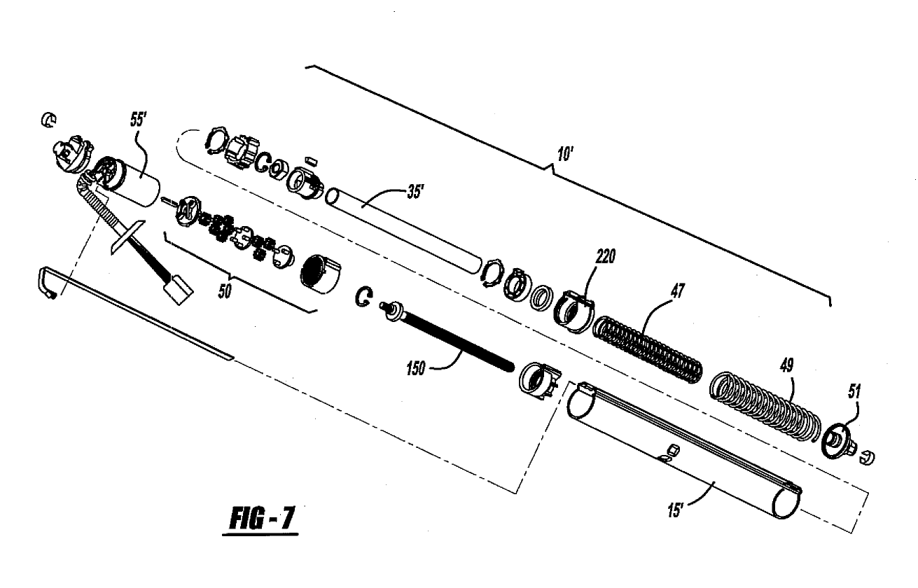

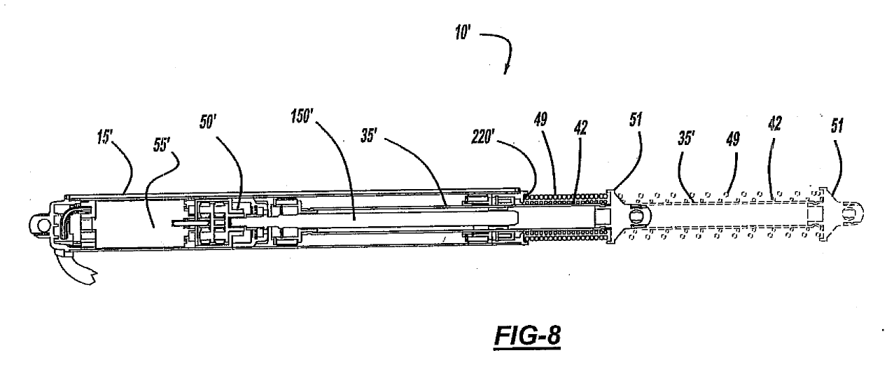

In FIGS. 7 and 8, another embodiment is shown wherein like parts are indicated by like prime numerals. The construction of the drive unit 10′ is substantially the same as in the previously described embodiments. The biasing member in this embodiment, however, is provided in the form of a pair of springs, where one of the pair of springs is an inner spring 47 and the other of the pair of springs is an outer spring 49. The inner spring 47 is coaxially mounted along an outer surface of the inner tube 35′. The outer spring 49 extends over the inner spring 47 in a concentric manner and is also generally coaxial with the inner tube 35′. The springs 47, 49 are compressed between the end cap 220′ and a second end cap 51 fixedly secured to the second end of the inner tube 35′ for continuously biasing the inner tube 35′ in the direction of the arrow indicated in FIG. 8.

In use, the liftgate drive unit 10′ of this embodiment has one end coupled to a liftgate of a vehicle and another end coupled to the body of a vehicle. The description of the operation of the drive unit from the previous embodiments, particularly with regard to the actuation of the inner tube relative to the outer tube between the retracted and extended positions is similar to that already described. As best shown in FIG. 8, the springs 47, 49 are compressed between the end cap 220′ and the second end cap 51 so as to assist in the opening of the liftgate by forcing the inner tube 35′ axially apart from the outer tube 15′. This is particularly useful during manual actuation of the liftgate when the electric motor 55′ of the drive unit 10′ is not utilized. Additionally, the springs 47, 49 also decrease a force needed from the actuator to power open the liftgate.

It should be appreciated that the biasing member may be provided in the form of one or more springs. If more than one spring is used, the springs may be arranged other than as shown in the illustrated embodiment. For example, the springs may be arranged end to end rather than nested, as illustrated. The springs may also be the same or differ in terms of size and/or spring constant. All of these factors in general depend on the desired amount of assist and the design characteristics of various vehicle liftgates.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

1. A drive unit for driving a liftgate of a motor vehicle between closed and open positions, said drive unit comprising:
an outer tube having an end configured to couple the drive unit to one of the liftgate or the motor vehicle;
an inner tube having an end configured to couple the drive unit to the other of the liftgate or the motor vehicle, the inner tube being telescopically engaged with the outer tube, the inner tube being movable between a retracted position and an extended position relative to the outer tube; and
an actuator operative for actuating the inner tube relative to the outer tube between the retracted position and the extended position and causing movement of the liftgate between closed and open positions, respectively, the actuator being housed within the outer tube.

2. The drive unit of claim 1 wherein the actuator includes a motor and gear set.

3. The drive unit of claim 1 including a biasing member connected between the outer tube and the inner tube, the biasing member biasing the inner tube relative to the outer tube and assisting actuation of the inner tube toward the extended position.

4. The drive unit of claim 1, wherein the biasing member is an assist strut coupled between the outer tube and the inner tube.

5. The drive unit of claim 1, wherein the biasing member includes at least one spring biasing the inner tube toward the extended position relative to the outer tube.

6. The drive unit of claim 5, wherein the at least one spring includes an inner spring and an outer spring arranged concentrically over the inner spring, the inner and outer springs working conjointly to bias the inner tube toward the extended position relative to the outer tube.

7. A drive unit for driving a liftgate of a motor vehicle between closed and open positions, said drive unit comprising:
an extendable strut for movement between retracted and extended positions corresponding with the closed and open positions of the liftgate, respectively;
a screw drive for extending the extendable strut; and
a motor and gear set for actuating the screw drive, wherein the motor and gear set are supported by the extendable strut.

8. The drive unit of claim 7, wherein the motor includes an output that is on axis relative to the gear set.

9. The drive unit of claim 7, wherein the extendable strut has an outer tube having a hollow interior within which an inner tube is telescopically disposed, the screw drive being interconnected with the inner tube for moving the inner tube between retracted and extended positions relative to the outer tube.

10. The drive unit of claim 9, wherein the motor and gear set are disposed within the hollow interior of the outer tube.

11. The drive unit of claim 9, wherein the motor includes an outwardly extending driveshaft that is co-lineal with respect to the inner tube.

12. The drive unit of claim 8, wherein the extendable strut includes a tailgate connector on one side and a vehicle body connector on another side, the motor being positioned on the same side of the strut as the vehicle body connector.

13. The drive unit of claim 7, wherein the gear set is a planetary gear set which includes: a main pinion gear coupled with the driveshaft, a first carrier plate, a first set of planetary gears meshed with the main pinion gear and supported by the first carrier plate, a carrier plate pinion gear supported by the first carrier plate, a second carrier plate, a second set of planetary gears meshed with the carrier plate pinion gear and supported on the second carrier plate, and wherein the second carrier plate is connected to a screw.

14. The drive unit of claim 9 including a biasing member operatively coupled between the outer tube and the inner tube for biasing the extendable strut toward the extended position.

15. The drive unit of claim 14, wherein the biasing member is an assist strut coupled between the outer tube and the inner tube.

16. The drive unit of claim 7 wherein the motor includes a wire harness attached thereto for providing power to the motor, the wire harness routed through a roof of a vehicle.

17. The drive unit of claim 14, wherein the biasing member includes at least one spring biasing the inner tube toward the extended position relative to the outer tube.

18. The drive unit of claim 7 including an epicyclic transmission coupled to the motor.

19. The drive unit of claim 18, wherein the epicyclic transmission is back drivable and is formed of a plastic material.

20. A drive unit for driving a liftgate of a motor vehicle between closed and open positions, said drive unit comprising:
an extendable strut for movement between retracted and extended positions corresponding with the closed and open positions of the liftgate, respectively;
a screw drive for extending the extendable strut; and
a motor and gear set defining an epicyclic transmission for actuating the screw drive, wherein the motor and gear set are supported by the extendable strut.
